(19) United States
(12) Patent Application Publication
(10) Pub. No.: US 2007/0015400 A1
(43) Pub. Date: Jan. 18, 2007

(54) Modular edutainment system

(75) Inventors: Elliot Rudell, Torrance, CA (US); George T. Foster, Placerville, CA (US); Julio Sandoval, Wilmington, CA (US)

Correspondence Address: IRELL & MANELLA LLP, 840 NEWPORT CENTER DRIVE, SUITE 400, NEWPORT BEACH, CA, 92660, US

(73) Assignee: Elliot Rudell, Torrance, CA (US)

(21) Appl. No.: 11/488,240

(22) Filed: Jul. 17, 2006

Related U.S. Application Data
(60) Provisional application No. 60/699,601, filed on Jul. 18, 2005.

(51) Int. Cl. H01R 11/00

(52) U.S. Cl. 439/502

(57) ABSTRACT

An electronic learning and entertainment system that includes a plurality of housings that can be coupled to an electronic module. Each housing has a plurality of input devices. The electronic module can be plugged into one of the housings and generate outputs that are unique to the housing. The input devices and corresponding module outputs may be designed for play by a specific age group. Thus each housing can be operated by a user of a certain age. By way of example, one housing may be designed to by operated by an infant, another housing may be designed to be operated by a user in the 2-5 year age group, etc.

### REFERENCE TO CROSS-RELATED APPLICATION

This application claims priority to Provisional Application No. 60/699,601 filed on Jul. 18, 2005.

### BACKGROUND OF THE INVENTION

1. Field of the Invention

The present invention relates to an electronic learning and entertainment system. It should be noted that “edutainment” is a term commonly utilized in the toy industry to describe a product that functions in the dual capacity of both an educational learning product as well as an entertainment product. “Edutainment” is also used to describe the category for such products.

2. Prior Art

There have been marketed various interactive learning and entertainment systems. For example, Leapfrog marketed products under the names “LeapPad” and “Leapster” that provided electronic/human interaction. The LeapPad product included a plurality of different books, one of which could be placed on a housing. A user could touch a page of a book to produce a sound that is generated by electronic devices within the housing. Each book and each printed page within a book would produce a different sound. The different sounds typically coordinated with a story depicted by the printed pages of the book.

The Leapster product has no book accommodation, but included a screen that would display different images in response to input from the user. The Leapster product included an electronic port that would accept electronic cards. The interactive play of the game would vary depending on which card was inserted into the electronic port.

Fisher Price marketed a product under the name “Power Touch” which included a main housing and a plurality of printed books. One of the books could be placed on the housing. The product included touch pads that could be pressed by the user to generate sounds from the housing. Each book would produce different sounds.

The prior art products were designed for specific age groups of users. The products could not be used as the user progressed in age beyond the age group for which the product was intended. Instead, the parents would typically have to purchase a new system that was now age-graded to their growing child. It would be desirable to provide an interactive electronic learning and entertainment system that can be used by multiple age groups.

### BRIEF SUMMARY OF THE INVENTION

An electronic learning and entertainment system that includes a plurality of housings and an electronic module. Each housing has a plurality of input devices that are unique to the housing, and compatible with the specific age of child for which it was intended. The electronic module can be coupled to one of the housings and generate outputs that are unique to the coupled housing.

### BRIEF DESCRIPTION OF THE DRAWINGS

FIG. 1 is an illustration of a partially cut-away view of an electronic learning and entertainment system;

FIG. 2 is an illustration of a front sectional view of the electronic learning and entertainment system;

FIG. 3 is an illustration of a housing of the electronic learning and entertainment system;

FIG. 4 is an illustration of another housing of the electronic learning and entertainment system;

FIG. 5 is an illustration of another housing of the electronic learning and entertainment system; and,

FIG. 6 is an illustration of an alternate embodiment of the housing shown in FIG. 5.

### DETAILED DESCRIPTION

Disclosed is an electronic learning and entertainment system that includes a plurality of housings that can be coupled to an electronic module. Each housing has a plurality of input devices. The electronic module can be plugged into one of the housings and generate outputs that are unique to the housing. The input devices and corresponding module outputs may be designed for play by a specific age group. Thus each housing can be operated by a user of a certain age. By way of example, one housing may be designed to be operated by an infant, another housing may be designed to be operated by a user in the 2-3 year age group, etc.

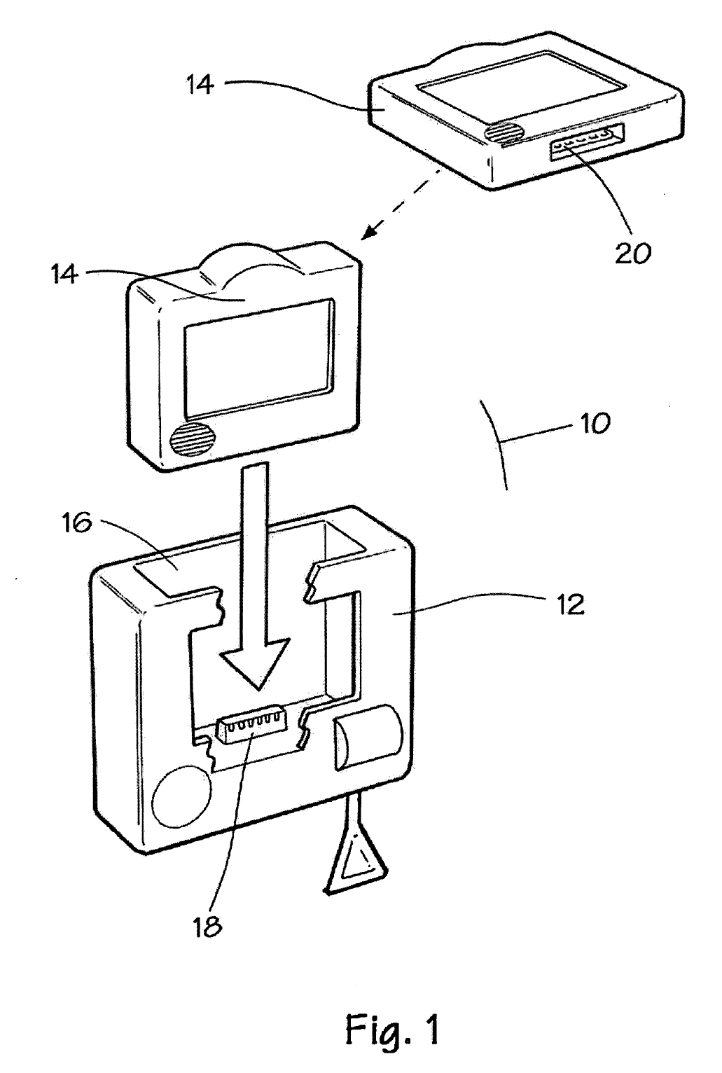

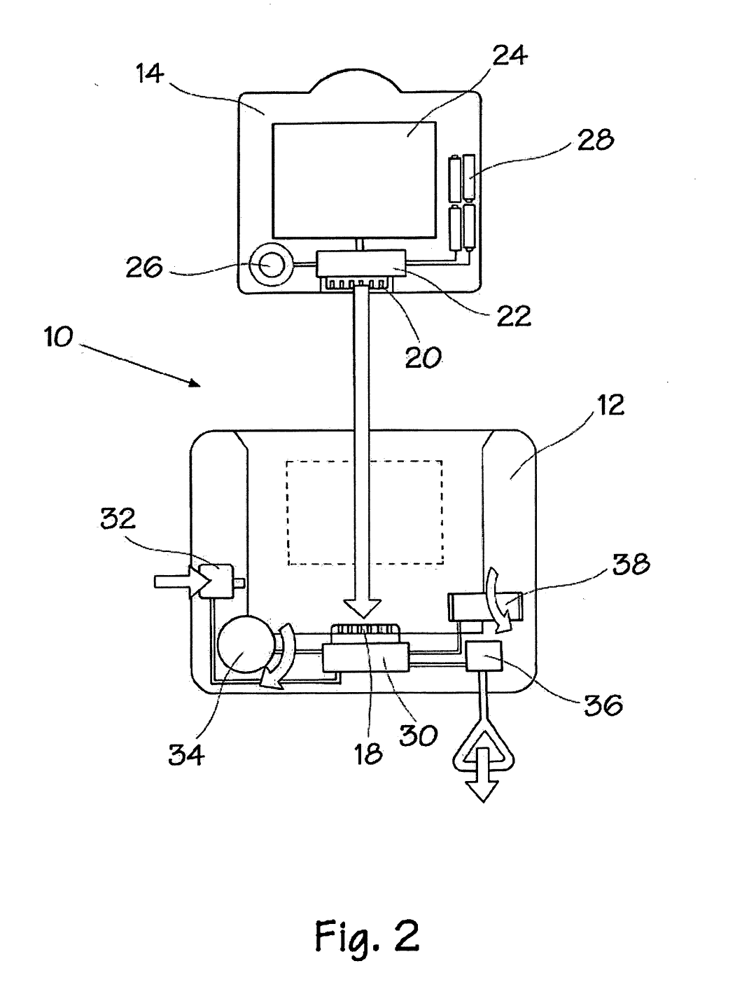

Referring to the drawings more particularly by reference numbers, FIGS. 1 and 2 show an embodiment of an electronic learning and entertainment system 10. The game 10 includes a housing 12 and an electronic module 14. The housing 12 may include a port 16 that can receive the electronic module 14. Within the port 16 is an electrical connector 18 that can mate with a corresponding electrical connector 20 of the module 14.

The module 14 may include a processor 22 that performs operations in accordance with data and instructions as is understood in the art. The instructions and data may be stored in memory (not shown).

The processor 22 may connected to a display screen 24 and a speaker 26. The processor 22 may create output signal that generate images displayed by the screen 24 and sound emitted by the speaker 26. The module 14 and housing 12 may be powered by batteries 28.

The housing 12 may include an electrical device 30 with a plug 18 that is connected to the connector 20. Coupled to electrical device 30 is a plurality of input devices 32, 34, 36 and 38. The input devices 32, 34, 36 and 38 can be operated by a user. Each input device 32, 34, 36 and 38 may provide a different mode of play. For example, input device 32 may be a subassembly that can slide, input device 34 may rotate, input device 36 can be pulled, and input device 38 can be rolled by the user.

Each input device 32, 34, 36 and 38 may include a mechanical to electrical transducer (not shown) that provides an electrical output which corresponds to movement of the device 32, 34, 36 and 38. For example, the transducer of input device 32 can provide an electrical output that corresponds with a sliding motion of the device 32. The electrical device 30 may route the transducer outputs to the processor 22 of the module 14. The processor 22 may generate outputs in response to the inputs from devices 32, 34, 36 and 38. For example, the processor 22 may vary the image displayed by the screen 24 and/or sound generated by the speaker 26 as the user slides the input device 32. For example, in an embodiment designed for a young child, input device 32 might be styled to look like a turtle. As the child slides the turtle, an image of a turtle can appear to be moving on the screen 24, designating both the selection, by the child, of the turtle input device and also the activation of that device.

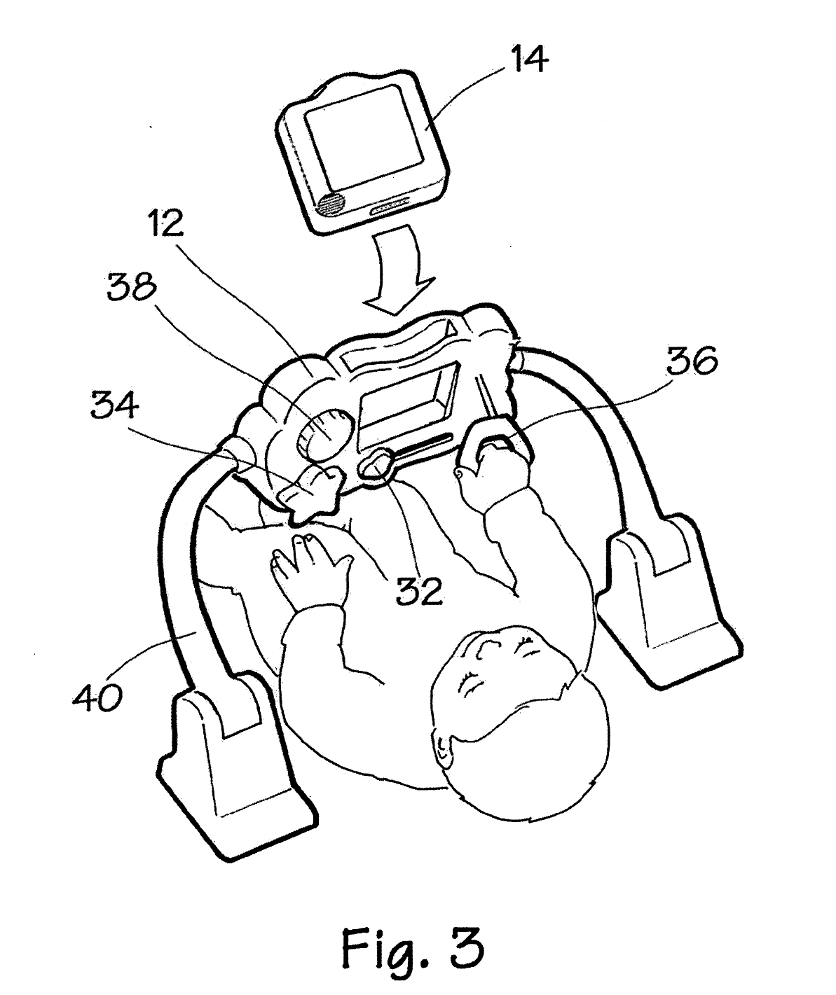

The electrical device 30 may store an identification that is unique to the housing. The processor 22 of the module 12 can read the ID to determine the type of housing and generate outputs that are unique to the housing. For example as shown in FIG. 3, the housing 12 may be designed to be operated by an infant somewhat older than a newborn. The input devices 32, 34, 36 and 38 may be adapted to be played with by the infant as they lay on the floor. The module processor 22 reads the identification within the housing to determine that the housing is of the type that can be operated by an infant. The module 14 then generates outputs that corresponding to the play of the infant housing. The housing 12 may be supported by a floor support assembly 40 as shown in FIG. 3.

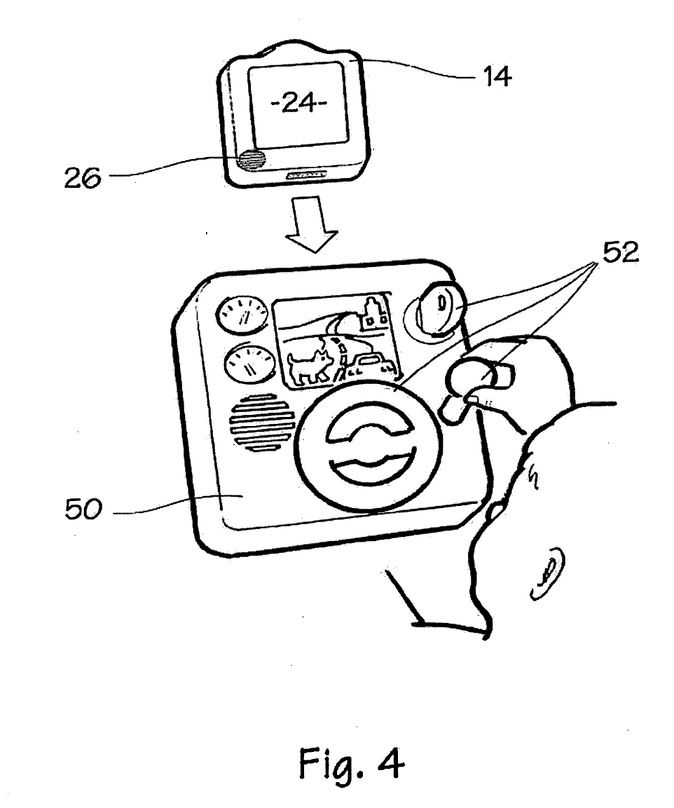

As shown in FIG. 4, the electronic module 14 can be plugged into a housing 50 that is designed to be operated by a user in an age group older that an infant, for example, ages 2-5. The housing 50 includes a plurality of input devices 52 that can be operated by the user. Operation of the input devices 52 may cause the module to generate outputs on the screen 24 and/or speaker 26. The outputs generated by the module for housing 50 are different than the outputs generated when the module is plugged into housing 12.

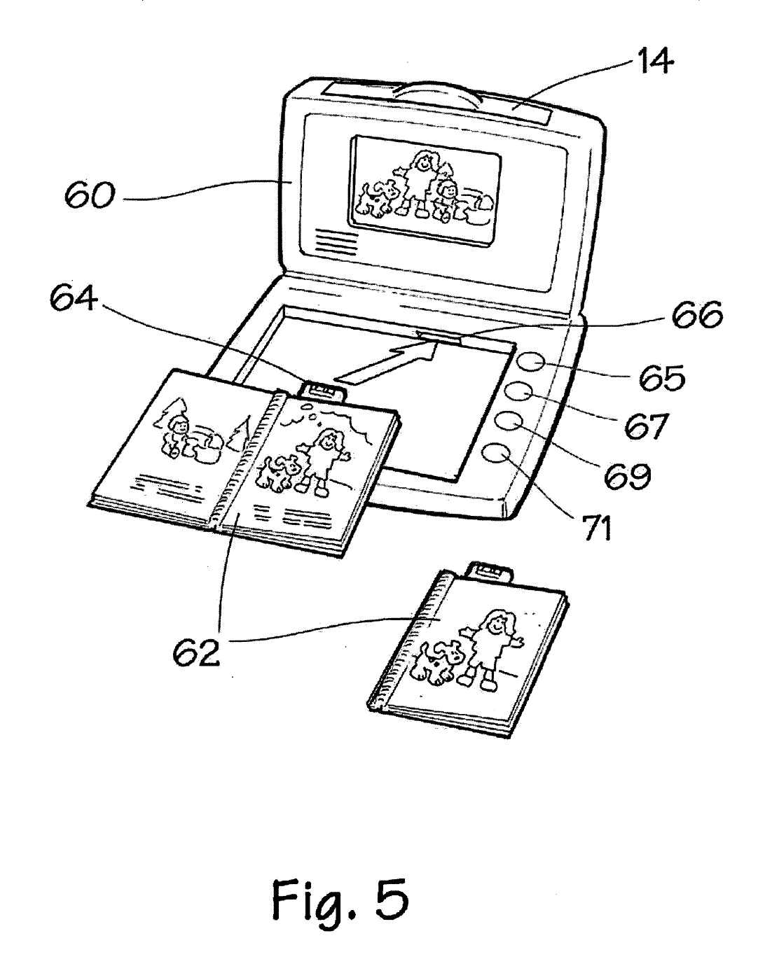

FIG. 5 shows another housing 60 that is designed to be operated with yet another age group, for example ages 3-7. This age group is typically becoming involved in reading activity, and there is less of a requirement for gross motor skill manipulation activation as provided for in the design of the two prior-described housings 12 and 50. The housing 60 may accept one of a plurality of books 62. Each book 62 may include an electronic card 64 that plugs into a corresponding port 66 of the housing 60. The electronic card 64 may contain electronic information that causes the module 14 to generate visual and/or audio output when a user interacts with the book 62. By way of example, when a user turns a page of the book the module 14 may generate images and/or sounds that correspond to the images and/or story displayed by the book 62. User input, in this embodiment, can be activated as the child presses a button such as 65, 67, 69 or 71 to either select an answer to a question (EXAMPLE: Which dog is bigger?), or to make a selection to determine the further direction of a story (Example: Who do you want to drive the car—the mommy or the daddy?).

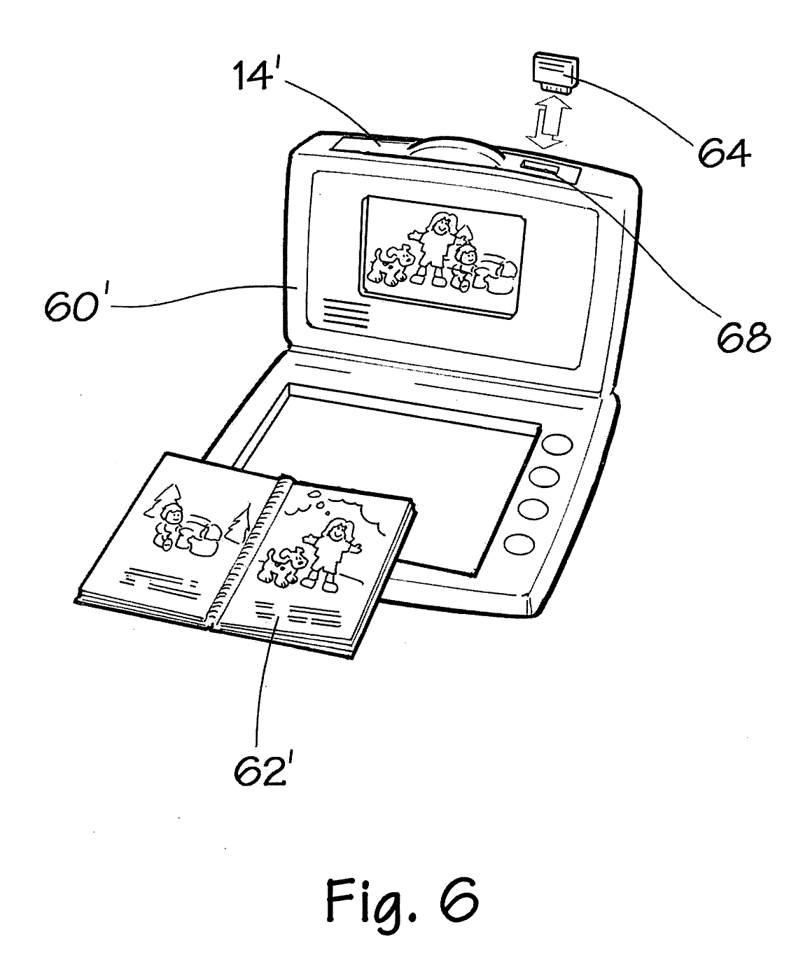

As an alternate embodiment, the electronic card 64 may be separate from the book 62′ and plugged directly into a port 68 of a module 14 that is coupled to a housing 60′ as shown in FIG. 6.

It should be noted that the child's interaction with the system could include gaming activity, by means of the child activating buttons 65, 67, 68, and 71; or, when the electronic module 14 is installed in alternative housings, by way of example 12 or 50, when the child manipulates devices 32, 34, 36, 38, or 52.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An electronic learning and entertainment system, comprising:
a plurality of housings, each housing having a plurality of input devices that are unique to said housing; and,
an electronic module that can be coupled to said housings, said electronic module providing different outputs for each housing.

2. The electronic learning and entertainment system of claim 1, wherein said electronic module includes a processor and a screen.

3. The electronic learning and entertainment system of claim 2, wherein said electronic module includes a speaker.

4. The electronic learning and entertainment system of claim 1, wherein each housing has input devices that are adapted to be played by different age groups.

5. The electronic learning and entertainment system of claim 1, further comprising a plurality of books that can be coupled to one of said housings.

6. The electronic learning and entertainment system of claim 1, wherein each housing includes an electronic device that has a unique identification that is read by said electronic module.

7. The electronic learning and entertainment system of claim 1, wherein said electronic module and said housings are coupled by an electrical connector.

8. An electronic learning and entertainment system, comprising:
a plurality of housings, each housing having a plurality of input devices that are unique to said housing; and,
an electronic module means for being coupled to said housings and providing different outputs for each housing.

9. The electronic learning and entertainment system of claim 8, wherein said electronic module means includes a processor and a screen.

10. The electronic learning and entertainment system of claim 9, wherein said electronic module means includes a speaker.

11. The electronic learning and entertainment system of claim 8, wherein each housing has input devices that are adapted to be played by different age groups.

12. The electronic learning and entertainment system of claim 8, further comprising a plurality of books that can be coupled to one of said housings.

13. The electronic learning and entertainment system of claim 8, wherein each housing includes an electronic device that has a unique identification that is read by said electronic module means.

14. The electronic learning and entertainment system of claim 8, wherein said electronic module means and said housings are coupled by an electrical connector.

15. A method for playing an electronic learning and entertainment system, comprising:
coupling a first housing to an electronic module;
operating a plurality of input devices of the first housing;
generating a plurality of first housing outputs from the electronic module;
coupling a second housing to the electronic module;
operating a plurality of input devices of the second housing; and,
generating a plurality of second housing outputs that are different than the first housing outputs.

16. The method of claim 16, further comprising coupling a book to the second housing.

17. The method of claim 16, wherein the operation of the first input devices include pulling a handle.

18. The method of claim 16, wherein the first and second outputs include displaying images on a screen.

19. The method of claim 18, wherein the first and second outputs include generating sound.
